(19) United States
(12) Patent Application Publication
(10) Pub. No.: US 2023/0134881 A1
(43) Pub. Date: May 4, 2023

(54) SLIDING ELEMENT, IN PARTICULAR PISTON RING, AND METHOD FOR PRODUCING SAME

(71) Applicant: FEDERAL-MOGUL BURSCHEID GMBH, BURSCHEID (DE)

(72) Inventors: JOHANNES ESSER, ODENTHAL (DE); STEFFEN HOPPE, OVERATH (DE); CHRISTIANE BAUER, BURSCHEID (DE)

(21) Appl. No.: 17/904,615

(22) PCT Filed: Feb. 19, 2021
(86) PCT No.: PCT/EP2021/054135

§ 371 Date: Aug. 19, 2022

(30) Foreign Application Priority Data
Feb. 21, 2020 (DE) 10 2020 202 259.3

(51) Int. Cl. F16J 15/34; F16J 9/26; C21D 8/10; C22C 38/18; C21D 9/00

(52) U.S. Cl. CPC F16J 15/3496; C21D 8/105; C21D 9/0068; C22C 38/18; F16J 9/26; C21D 2211/001; C21D 2211/008; C21D 2221/10

(57) ABSTRACT

A sliding element, in particular a piston ring, includes a base material of martensitic or austenitic stainless steel having a chromium content of at least 6.0% by mass and a nitrided layer having a surface hardness of up to 950 HV1. A method of producing such a sliding layer is also provided.

### BACKGROUND

### Technical Field

The invention relates to a sliding element, in particular a piston ring, which exhibits good overall wear resistance and improved fatigue strength, and to a method for producing the same.

### Related Art

When reducing the carbon dioxide emissions of internal combustion engines, fuel consumption plays a key role. This is influenced, inter alia, also by the frictional losses of the sliding elements in the engine, in particular in the region of the pistons. The sliding elements, for example piston rings, have running surfaces at which they are in sliding contact with a friction partner. This tribological system is complex and is significantly determined by the material pairing of the friction partners.

Sliding elements such as piston rings are subject on the one hand to increasingly higher requirements in terms of fatigue strength, driven among other things by increased load conditions, for example by increased cylinder peak pressures, and by reduced piston ring dimensions (in particular axial ring height). On the other hand, in particular with modern engines, thermal and mechanical loads also occur on the sliding elements such as piston rings, pistons or cylinder liners in internal combustion engines, which necessitate high wear resistance throughout a long service life. To ensure this durability, sliding elements such as piston rings can be provided with a wear-resistant layer, for example on the outer flank surface of a piston ring.

In summary, therefore, there is a need for sliding elements in internal combustion engines, which exhibit the most favorable friction behavior possible throughout the entire service life and yet ensure both significantly increased fatigue strength and the required protection against wear.

Piston rings are known from the prior art, the flanks of which are nitrided in part or in full and the running surfaces of which have a different coating at least in part.

DE 102 21 800 A1 discloses a steel piston ring having a running surface, an inner surface as well as upper and lower flanks provided therebetween, with the running surface being provided at least in part with a thermal spray layer as running surface coating and a nitrided layer created by plasma nitriding being provided at least on the flanks.

US 6 508 473 B1 describes a piston ring having a nitrided layer on the upper and lower flanks or on the upper and lower flanks and the inner circumferential surface, and a hard film formed by ion plating on the outer circumferential surface.

DE 10 2005 023 627 A1 reveals a steel piston ring having a running surface chambered on one side, with the running surface being coated with a chromium-ceramics-based wear-resistant layer having micro-cracks and at least the flanks being provided with a wear-reducing nitrided layer.

DE 10 2005 011 438 B3 discloses a method for producing wear-resistant layers on a piston ring base body consisting of steel or cast iron, with the running surface region being first provided at least in part with an at least single-layer thermal spray layer on the basis of nitrogen-affine metallic elements, and then at least the flanks and the running surface with the spray layer applied thereto are subjected to a nitriding process.

Even though such sliding elements have layers with satisfactory wear resistance, they show reduced fatigue strength under the aforementioned load conditions.

### SUMMARY

An object is to provide a sliding element, preferably a piston ring, which exhibits good overall wear resistance and improved fatigue strength, and a method for producing the same.

Wear resistance is basically ensured by providing a nitrided layer in a base material of martensitic or austenitic stainless steel having a chromium content of at least 6.0% by mass. Chromium contents of at least 11.0% by mass or at least 17.0% by mass, respectively, advantageously increase the wear resistance of the sliding element.

The fatigue strength of surface layer-treated components depends to a large extent on the brittleness of the surface layer zone of the respective component under consideration. Nitriding of sliding elements is to be regarded as such a surface layer treatment. Various test series have shown that the desired reduction in brittleness can be achieved by lowering the hardness of the nitrided layer. In particular, this can be achieved by a specific process during nitriding.

The nitriding of piston rings made of high-chromium steels is carried out in such a way that the brittleness of the nitrided layer is reduced. In particular, the reduction of brittleness is achieved by lowering the hardness of the nitrided layer. It has been shown that a surface hardness of up to 900 HV1, measured orthogonally to the nitrided layer, leads to a significant improvement in fatigue strength.

The structure of a sliding element comprising a base material of martensitic or austenitic stainless steel having a chromium content of at least 6.0% by mass and a nitrided layer having a surface hardness of up to 950 HV1 therefore ensures the desired protection against wear while providing high fatigue strength.

Surprisingly, the significantly lower hardness compared to conventional nitrided layers in high-chromium steels is achieved by a significantly higher temperature during nitriding.

When supplying a mixture of ammonia and ammonia cracking gas under increased temperatures, the ammonia is broken down on the metallic sliding element surface until atomic nitrogen is absorbed. This absorbed nitrogen then diffuses into the metallic piston ring surface as a result of a nitrogen concentration gradient, thus forming a nitrided layer. The formation of the nitrided layer is determined by the solubility of the high-chromium piston ring steel material.

The process conditions of nitriding are selected such that the nitrogen solubility of the base material is exceeded so that already during nitriding iron and chromium nitride precipitates are formed that may continue to grow in the further course. The increasingly growing iron and chromium nitride precipitates affect the metallurgical strains in the iron lattice in such a way that the increase of lattice strains is limited. These reduced lattice strains are directly related to the brittleness and hardness of the nitrided layer. It has been surprisingly found that by nitriding the base material at a temperature of between at least 600° C. and at most 700° C., the aforementioned effects can be achieved without the undesired so-called braunite phase forming in the diffusion zone of the nitrided layer. These advantageous effects are particularly pronounced at temperatures of at least 630° C. and at most 650° C., respectively. The aforementioned upper temperature limits ensure that the risk of braunite formation is avoided.

Nitriding is preferably carried out for a duration of 15 to 60 minutes.

Surface hardnesses of preferably at least 700 HV1 and/or up to 900 HV1 result in even better fatigue strength. Likewise, chromium contents of at least 11.0% by mass chromium, or at least 17.0% by mass chromium, respectively, advantageously increase wear resistance.

According to an embodiment, the sliding element additionally comprises a wear-resistant layer, preferably selected from a PVD layer or electroplated layer, particularly preferably a DLC layer, as the outermost layer on at least part of the surface of the sliding element. Such a wear-resistant layer further increases the wear protection of the sliding element. Furthermore, when combining the nitrided layer according to the invention with a wear-resistant layer, the cracking risk in the nitrided layer at high pressure, caused by very high dynamic gas pressures due to pre-inflammation processes or also so-called knocking in the engine, is reduced in a synergistic manner.

Advantageously, the sliding element is a piston ring and the wear-resistant layer is applied to the outer circumferential surface and/or the flank of the piston ring. The cited regions of a piston ring benefit particularly strongly from the protection against wear provided by the wear-resistant layer.

According to an advantageous embodiment, the nitrided layer constitutes the outermost layer on at least part of the surface of the sliding element, preferably on the outer circumferential surface and/or the flank of a piston ring. Such a sliding element is particularly easy to manufacture, but still exhibits satisfactory properties in terms of wear resistance and fatigue strength.

Preferably, the nitrided layer has a nitriding hardness depth Nht 700 HV0.1, measured according to ISO6621-2, section 4.2.15, of between 20 and 100 µm. The aforementioned nitriding hardness depth ensures the desired wear resistance and fatigue strength.

Advantageously, the thickness of the wear-resistant layer is at least 3 µm, preferably at least 10 µm. In this value range, a particularly high wear resistance of the wear-resistant layer can be achieved.

Preferably, the nitrided layer consists exclusively of a single-zone nitrided layer with continuous hardness decrease from the outer surface into the nitrided-layer-free base material. In other words, the nitrided layer does not exhibit a multi-stage discontinuous, unsteady nitrided layer formation. This embodiment is characterized by excellent wear resistance and fatigue strength.

Advantageously, the base material of the sliding element has a uniform, fine-grained tempered structure without carbide accumulations and a maximum carbide grain size of 50 µm. This advantageously increases the fatigue strength of the sliding element.

According to an advantageous embodiment, the base material is subjected to a cleaning treatment prior to nitriding. This allows surface impurities to be removed.

Preferably, prior to nitriding, the base material is heated in a gas nitriding facility to a pretreatment temperature of between 450° C. and 550° C. with the addition of nitrogen gas.

Advantageously, the base material is subjected to a single- or multi-stage etching treatment prior to nitriding, with ammonia as well as etchants, in solid or liquid form, being added. This leads to the removal of the passive oxide layer, formed by the elements chromium and oxygen. Furthermore, initial nitride nucleation occurs on the piston ring surface.

According to an advantageous embodiment, nitriding is carried out with the addition of ammonia and optionally nitrogen and/or hydrogen.

Preferably, during heating to the nitriding temperature, at least one holding phase is provided during which the base material is held at a temperature lower than the nitriding temperature.

### BRIEF DESCRIPTION OF THE DRAWINGS

In the following, the basic idea of the invention will be explained in more detail by way of example with reference to the drawings in which

FIG. 1 shows a comparison of the surface hardnesses of a conventionally nitrided piston ring (Var. 1) and a piston ring nitrided according to the invention (Var. 2), measured according to HV1 and HV0.5;

FIG. 2 shows a comparison of the piston ring-specific fatigue strength of the conventionally nitrided piston ring (Var. 1) and the piston ring nitrided according to the invention (Var. 2); and

FIG. 3 shows a comparison of the metallographic transverse microsections of the conventionally nitrided piston ring (Var. 1) and the piston ring nitrided according to the invention (Var. 2), wherein both piston rings were additionally provided with a PVD wear-resistant layer.

### DETAILED DESCRIPTION

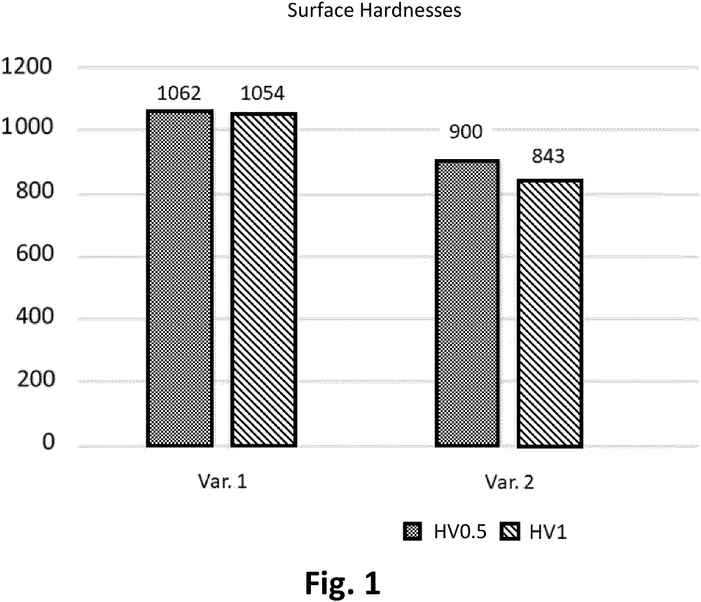

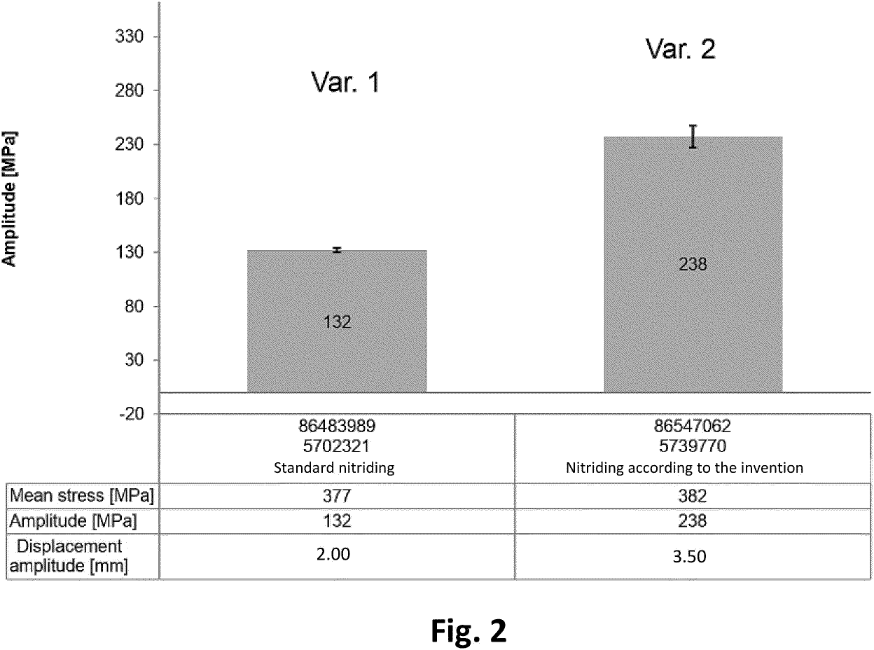

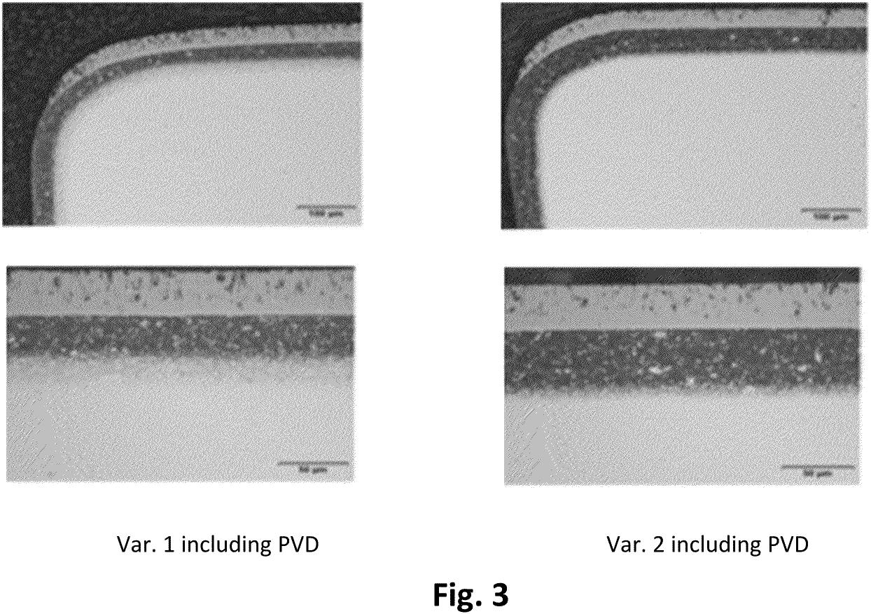

The expected connection between the surface hardness of the nitrided layer and the fatigue strength of accordingly nitrided piston rings is proven by the results shown in FIGS. 1 and 2: On the one hand, the method leads to significantly reduced surface hardnesses of the nitrided layer (cf. FIG. 1). This reduced surface hardness in turn leads to a significantly increased fatigue strength, as shown by FIG. 2. The piston ring-specific fatigue strength was derived in the measurement method forming the basis for FIG. 2 by determining the mean stress and the stress amplitude for fatigue strength-typical load cycles 10⁷. The growing of the iron and chromium nitride precipitates preferred according to the invention is further manifested in an enhanced etchability of the nitrided layer with 1% alcoholic nitric acid solution in the metallographic transverse microsection, as shown in FIG. 3.

The following additional embodiment example again illustrates the effect of nitriding according to the invention on hardness: The surface hardnesses according to Table 1 were measured on the nitrided layer of a sliding element nitrided according to standard methods. In contrast, the surface hardnesses according to Table 2 were measured on the nitrided layer of a sliding element nitrided according to the method of the invention. As can be clearly seen by comparing the two tables, the method according to the invention leads to significantly reduced surface hardnesses.

TABLE 1

| | HV1 | HV 0.5 | HV 0.3 | HV 0.2 | HV 0.1 | HV 0.05 |
|---|---|---|---|---|---|---|
| 1 | 1150 | 1207 | 1192 | 1268 | 1275 | 1416 |
| 2 | 1172 | 1194 | 1281 | 1257 | 1307 | 1246 |
| 3 | 1159 | 1183 | 1167 | 1246 | 1359 | 1339 |
| 4 | 1155 | 1156 | 1200 | 1214 | 1275 | 1246 |
| 5 | 1120 | 1131 | 1272 | 1192 | 1345 | 1339 |
| ∅ | 1151 | 1175 | 1222 | 1233 | 1339 | 1317 |

TABLE 2

| | HVI | HV 0.5 | HV 0.3 | HV 0.2 | HV 0.1 | HV 0.05 |
|---|---|---|---|---|---|---|
| 1 | 765 | 885 | 932 | 899 | 971 | 986 |
| 2 | 789 | 841 | 832 | 994 | 962 | 1246 |
| 3 | 760 | 849 | 909 | 934 | 1039 | 956 |
| 4 | 799 | 855 | 921 | 1002 | 950 | 956 |
| 5 | 784 | 765 | 938 | 979 | 1016 | 1339 |
| ∅ | 779 | 863 | 918 | 962 | 992 | 994 |

1. A sliding element, comprising:
a base material of martensitic or austenitic stainless steel having a chromium content of at least 6.0% by mass, preferably at least 11% by mass, particularly preferably at least 17% by mass, and
a nitrided layer having a surface hardness of up to 950 HV1, preferably at least 700 HV1 and/or up to 900 HV1.

2. The sliding element according to claim 1, including a wear-resistant layer selected from a PVD layer or electroplated layer, particularly preferably a DLC layer, as the outermost layer on at least part of the surface of the sliding element.

3. The sliding element according to claim 2, wherein the sliding element is a piston ring and the wear-resistant layer is applied a DLC layer to one or both of the outer circumferential surface and a flank of the piston ring.

4. The sliding element according to claim 1, wherein the nitrided layer constitutes the outermost layer on at least part of the surface of the sliding element and is applied to one or more of the outer circumferential surface and the flank of a piston ring.

5. The sliding element according to claim 1 one of, wherein the nitrided layer has a nitriding hardness depth Nht 700 HV0.1, measured according to ISO6621-2, section 4.2.15, of between 20 and 100 µm.

6. The sliding element according to claim 1 one of, wherein the wear-resistant layer has a thickness of at least 3 µm.

7. The sliding element according to claim 1 one of wherein the nitrided layer consists exclusively of a single-zone nitrided layer with continuous hardness decrease from the outer surface into the base material which is free of nitrides.

8. The sliding element according to claim 1 one of, wherein the base material has a uniform, fine-grained tempered structure without carbide accumulations and a maximum carbide grain size of 50 µm.

9. A method for producing a sliding element, comprising
providing a base material of martensitic or austenitic stainless steel having a chromium content of at least 6.0% by mass, and
nitriding the base material at a nitriding temperature of between at least 600° C. and 700° C.

10. The method for producing a sliding element according to claim 9, wherein the base material is subjected to a cleaning treatment prior to nitriding.

11. The method for producing a sliding element according to claim 9, wherein prior to nitriding, the base material is heated in a gas nitriding facility to a pretreatment temperature of between 450° C. and 550° C. with the addition of nitrogen gas.

12. The method for producing a sliding element according to claim 9, wherein the base material is subjected to a single- or multi-stage etching treatment prior to nitriding, with ammonia as well as etchants, in solid or liquid form, being added.

13. The method for producing a sliding element according to claim 9, wherein nitriding is carried out with the addition of ammonia.

14. The method for producing a sliding element according to claim 9, wherein during heating to the nitriding temperature, at least one holding phase is provided during which the base material is held at a temperature lower than the nitriding temperature.

15. The method for producing a sliding element according to claim 9, wherein during nitriding, the solubility limit for nitrogen in the base material is exceeded.

16. The sliding element of claim 1, wherein the chromium content is at least 11% by mass.

17. The sliding element of claim 1,wherein the chromium content is at least 17% by mass.

18. The sliding element of claim 1, wherein the hardness is at least 700 HV1.

19. The sliding element of claim 1, wherein the hardness is greater than 700 HV1 and less than 900 HV1.

20. The sliding element of claim 2, wherein the wear resistant layer comprises a DLC layer.

21. The sliding element of claim 6, wherein the thickness is at least 10 µm.

22. The method of claim 9, wherein the nitriding temperature is at most 650° C.

23. The method of claim 13, wherein at least one of nitrogen and hydrogen are added during nitriding.
